(19) United States
(12) Patent Application Publication
(10) Pub. No.: US 2014/0202084 A1
(43) Pub. Date: Jul. 24, 2014

(54) EMERGENCY EGRESS SYSTEM

(71) Applicant: QinetiQ North America, Inc., (US)

(72) Inventors: Robert Gene Holmes, JR., Worcester, MA (US); Jason Chua Yap, Brighton, MA (US); Edward J. Terrenzi, Fairhaven, MA (US)

(73) Assignee: QinetiQ North America, Inc., McLean, VA (US)

(21) Appl. No.: 13/889,572

(22) Filed: May 8, 2013

Related U.S. Application Data
(60) Provisional application No. 61/689,631, filed on Jun. 8, 2012.

(51) Int. Cl. F41H 5/22; F41H 5/26; F41H 7/04; F41H 5/013; E05F 15/20; E06B 5/10

(52) U.S. Cl. CPC F41H 5/226; E05F 15/2015; E06B 5/10; F41H 7/04; F41H 5/013; F41H 5/263
USPC 49/506; 89/36.08

(57) ABSTRACT

An emergency egress system and method features a mount securable externally to a vehicle hull about an opening therein and including a first portion of a releasable hinge structure. A window assembly includes a second portion of the releasable hinge structure hingedly attaching the window assembly to the mount over the hull opening. An ejection subsystem is releasably attached to the armor window automatically opening window assembly and ejecting the window assembly. A latch subsystem is actuatable from inside the hull (and optionally from outside the hull) releasably locking the armor window assembly with respect to the mount in a first configuration and unlocking the armor window assembly with respect to the mount in a second configuration.

### RELATED APPLICATIONS

This application claims benefit of and priority to U.S. Provisional Application Ser. No. 61/689,631 filed Jun. 8, 2012 under 35 U.S.C. §§119, 120, 363, 365, and 37 C.F.R. §1.55 and §1.78 and is incorporated herein by this reference.

### FIELD OF THE INVENTION

The subject invention relates to emergency egress systems and particularly with respect to armor window assemblies in one embodiment.

### BACKGROUND OF THE INVENTION

Armored ground vehicles used by military troops often include one or more armor window assemblies bolted to the hull of the vehicle. In one example, the MRAP vehicle has three to four armor window assemblies per side. In the case of a roll over accident, sometimes the crew members cannot exit the vehicle via its doors due to the weight of the armor or jamming of the doors. The armor windows are heavy as well.

Accordingly, those skilled in the art have attempted to devise emergency egress systems. See U.S. Pat. No. 8,066,319 incorporated herein by this reference. In accordance with that patent, crew members are required to manually push to remove and eject the windshield transparent armor assembly from the exterior of the vehicle. See also Published Application No. US 2010/0242714; U.S. Pat. No. 7,029,038; the BAE Systems “Vehicle Emergency Escape” (VEE) windows, and American Defense Systems, Inc.'s “Egress Window,” all incorporated herein by this reference.

The armor window assembly can be very heavy and in some conditions it may be difficult or impossible to open or dislodge the armor window assembly. In one example, the armor window assembly weighed 300 pounds.

### SUMMARY OF THE INVENTION

In certain aspects of one preferred embodiment of the subject invention, the new emergency egress system is operable in less than three seconds, is windshield compatible, and has minimal impact to the window opening. It is fully resettable, it is secured against accidental release, and it is compatible with existing glass. One preferred embodiment enables a single hand operation and there is a window ejection/lift assist functionality. In one design, the system is configurable to drop the window or eject and hold the window to prevent damage to the glass during training. The system is useful in almost any vehicle orientation and is typically retrofitable so that few vehicle modifications are required. This system is also externally activatable.

Featured is an emergency egress system comprising a mount securable externally to a vehicle hull about an opening therein and including a first portion of a releasable hinge structure. A window assembly includes a second portion of the releasable hinge structure hingedly attaching the window assembly to the mount over the hull opening. An ejection subsystem is releasably attached to the armor window assembly and biases the armor window assembly outwardly to automatically open the window assembly, decouple the second portion of the hinge structure from the first portion of the hinge structure, and eject the window assembly. A latch subsystem is actuatable from inside the hull (and optionally from outside the hull) to releasably lock the armor window assembly with respect to the mount in a first configuration and to unlock the armor window assembly with respect to the mount in a second configuration to automatically eject the armor window assembly by operation of the ejection subsystem.

In one version, the second portion of the releasable hinge structure includes spaced tabs extending upwardly from the window assembly. The first portion of the releasable hinge structure then includes spaced outwardly extending bars on the mount each defining a slot receiving a tab therein.

One emergency egress system includes a mount securable externally to a vehicle hull about an opening therein and including a first portion of a releasable hinge structure and also a lip. A window assembly includes a second portion of the releasable hinge structure hingedly attaching the window assembly to the mount over the hull opening. The window assembly further includes a top edge spaced laterally from said releasable hinge structure for engagement under the mount lip. An ejection subsystem is releasably attached to the armor window assembly biasing the armor window assembly outwardly to automatically open the window assembly. The second portion of the hinge structure decouples from the first portion of the hinge structure. The window assembly top edge is driven into the mount lip. The window assembly pivots with respect to the mount and the window assembly is then ejected. In one version, a latch subsystem is actuatable releasably locking the armor window assembly with respect to the mount in a first configuration and unlocking the armor window assembly with respect to the mount in a second configuration to drive the window assembly away from the mount in the second configuration.

Also featured is an emergency egress method comprising coupling a window assembly to a mount via a decoupling hinge. The window assembly is biased to open via an ejection subsystem. The window assembly is closed with respect to the mount during field operations using a latch. In an emergency, the window assembly is unlatched whereupon it automatically opens. The hinge automatically decouples and the ejection subsystem automatically decouples from the window assembly. The window assembly is then ejected. The method may further include pivoting the window assembly with respect to the mount after the hinge decouples. Opening the window assembly may include pushing a bottom of the window outward using the latch.

The subject invention, however, in other embodiments, need not achieve all these objectives and the claims hereof should not be limited to structures or methods capable of achieving these objectives. Other objects, features and advantages will occur to those skilled in the art from the following description of a preferred embodiment and the accompanying drawings.

### BRIEF DESCRIPTION OF THE DRAWINGS

Other objects, features and advantages will occur to those skilled in the art from the following description of a preferred embodiment and the accompanying drawings, in which:

FIG. 1 is schematic three dimensional side view showing an example of an emergency egress system incorporated with a military vehicle;

FIG. 2A is a schematic three dimensional view showing the emergency egress system of FIG. 1 in the closed position;

FIG. 2B is a schematic three dimensional view of the emergency egress system of FIGS. 1 and 2A now in an opening position;

FIG. 3 is a schematic three dimension view showing several of the components of the mount assembly associated with an example of an emergency egress system;

FIG. 4 is a schematic three dimension view of an example of a window assembly;

FIG. 5 is a schematic side view showing additional details of an emergency egress system;

FIG. 6 is a schematic view showing the handle component of a latch subsystem;

FIG. 7 is a schematic cross sectional view showing several of the components of a latched subsystem in accordance with an example of the invention;

FIG. 8 is a schematic cross sectional side view of the latch assembly shown in FIG. 7;

FIGS. 9A-9C are schematic three dimensional views showing the operation of the latch subsystem;

FIG. 10 is another schematic partially cross sectional view of the latch subsystem;

FIGS. 11A-11C are schematic views showing the operation of the ejection subsystem in a roll over side orientation;

FIGS. 12A-12E are a schematic view of the ejection subsystem opening the window assembly and ejecting it when the vehicle is in an upright configuration; and

FIGS. 13A and 13B showing ejection of the window assembly for a vehicle in an upside down rollover configuration.

### DETAILED DESCRIPTION OF THE INVENTION

The figures depict various aspects associated with an emergency egress system in accordance with a preferred embodiment of the invention. One preferred system is single hand operable and ejects the armored window in most orientations of the vehicle. The system does not adversely impact the function of the existing armor window and may use existing transparent armor in the case of a retrofit kit mitigating cost. The ejection of the armor window is achieved via stored energy from, but not limited to, gas springs, coil springs, electromagnetic means, and the like. A locking cam mechanism, in addition to holding the window closed, will break the window from its mount in the event that the window sticks to the vehicle hull within its frame or mount.

When latched, the armor window assembly is held securely against the vehicle hull within the mount or frame. Preferably two side gas springs urge the top tabs of the window assembly into locked engagement in slots behind the top bars of the mount forming a hinge between the armor window assembly and the mount. Other features on the window assembly and the mount also assist in securing the window assembly within the mount. The latch itself also carries, if needed, some of the load imposed by the window assembly. The primary function of the latch, however, is to keep the window closed and secure until an emergency egress situation occurs and then the latch functions to open the window by urging the bottom portion of the window assembly outward and then the bottom portion of the window assembly is released from the latch assembly.

When the latch is released, it pushes one edge of the window assembly (e.g., the bottom) outward slightly to overcome any adhesion due to gaskets or the like. When the latch handle is fully turned, it releases from the window assembly. Now the two side gas springs drive the window bottom outward and upward. After a sufficient amount of travel, the hinge structure between the window assembly and the mount decouples. That is, the top tabs of the window assembly slide out from underneath the top bars of the mount. The top edge of the window assembly hits a top lip of the mount. Now, the side gas springs themselves decouple at their distal ends from the window assembly. So, at this point, there is nothing holding or retaining the window assembly with respect to the mount or vehicle and so it ejects and falls away allowing passenger egress out of the now vacant window opening.

System activation from the interior of the vehicle includes pulling the handle to disengage the pin interlock shown. The handle is then turned 180° counter clockwise and the window now ejects automatically in all orientation scenarios. During normal operation, with the vehicle upright, the window opens and then drops after an approximately 30° actuation. For a rollover on the side, the window opens 120+° and then drops clear away from the egress opening. With the vehicle upside down, the window opens and then immediately drops.

System activation from the exterior of vehicle may include a vehicle pull where a first responder attaches the chain to the handles and the responding vehicle pulls the window off. Another manual exterior release is possible. The exterior release cover is removed (it is typically held on with magnets). The square drive is pushed toward the vehicle 0.75 inches and turned 180° counter clockwise and then the first responder must stand clear of the window drop area. Pushing the square drive inward and turning it has the same effect as pulling and turning the interior handle.

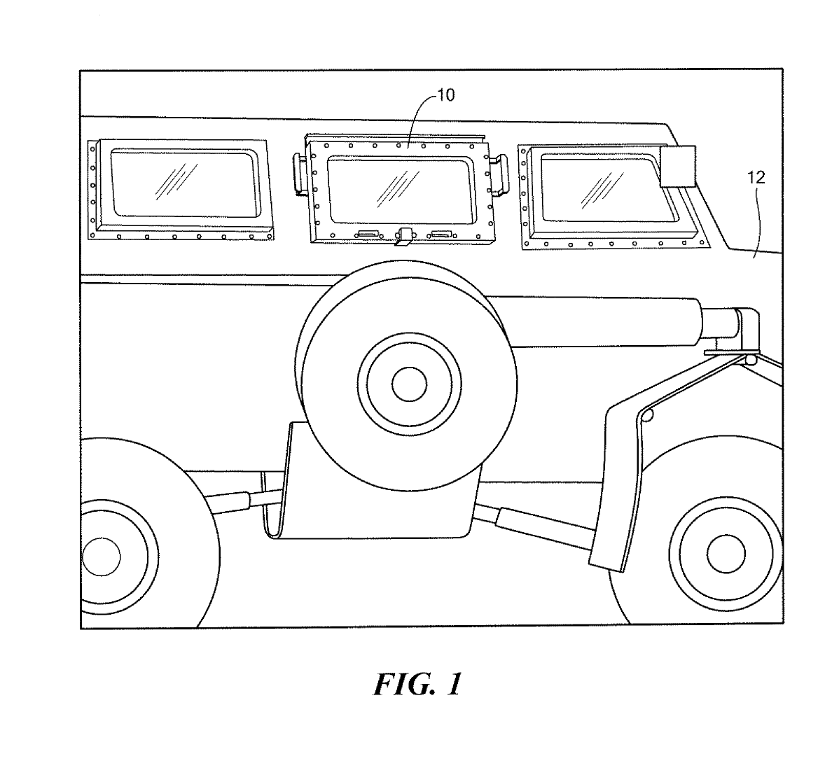

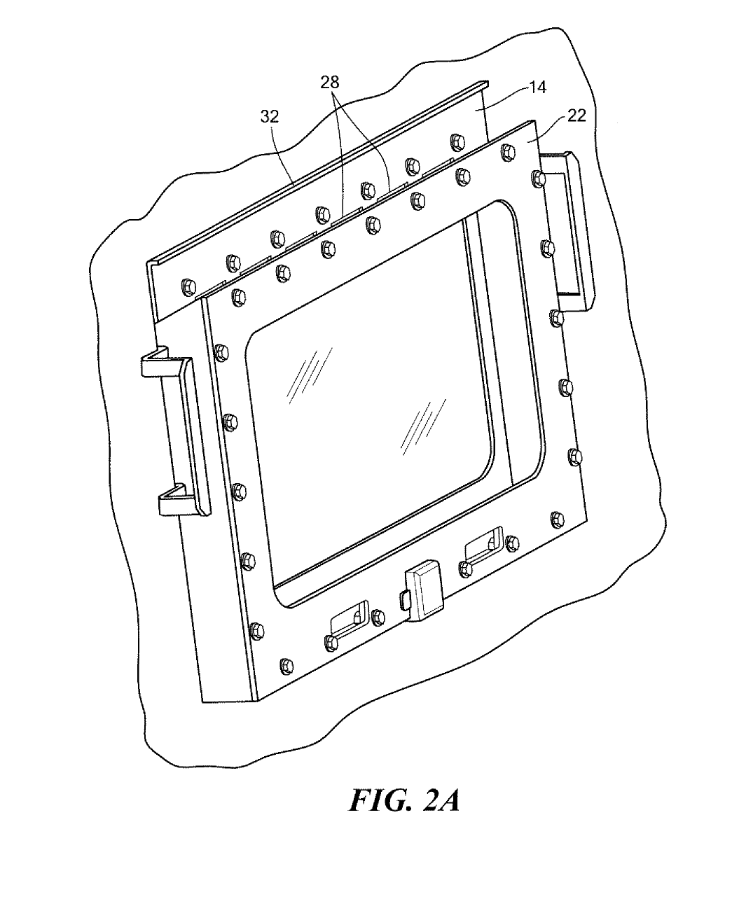

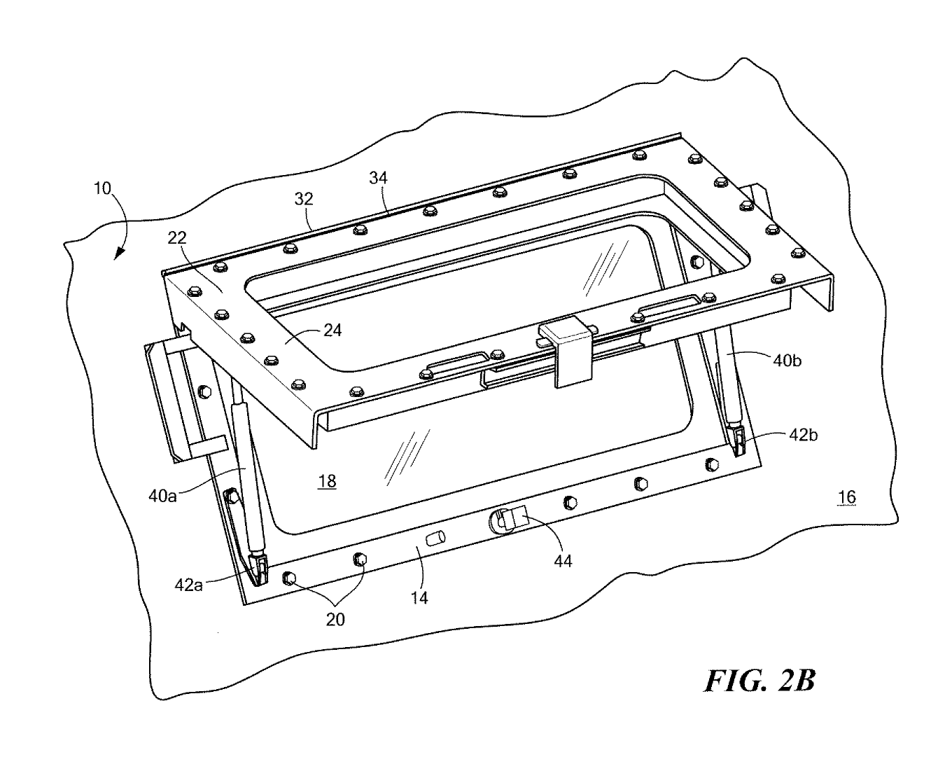

FIG. 1 shows one version of an emergency egress system 10 for military vehicle 12. One preferred system, FIGS. 2A-2B includes mount 14 securable externally to vehicle hull 16 about opening 18 using, for example, fasteners 20. Window assembly 22 includes frame 24 for an armor window.

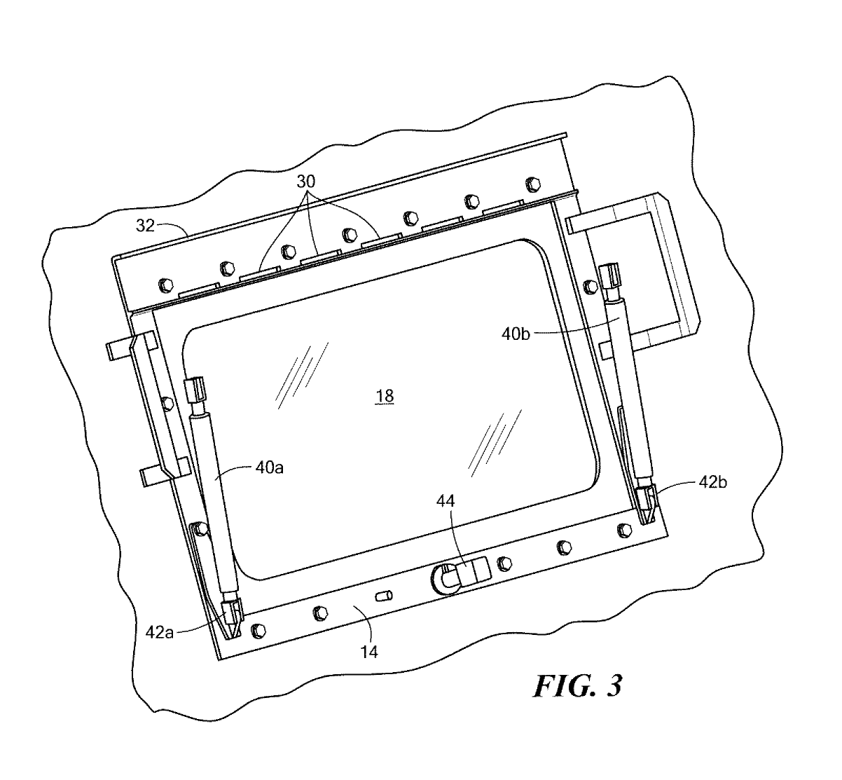

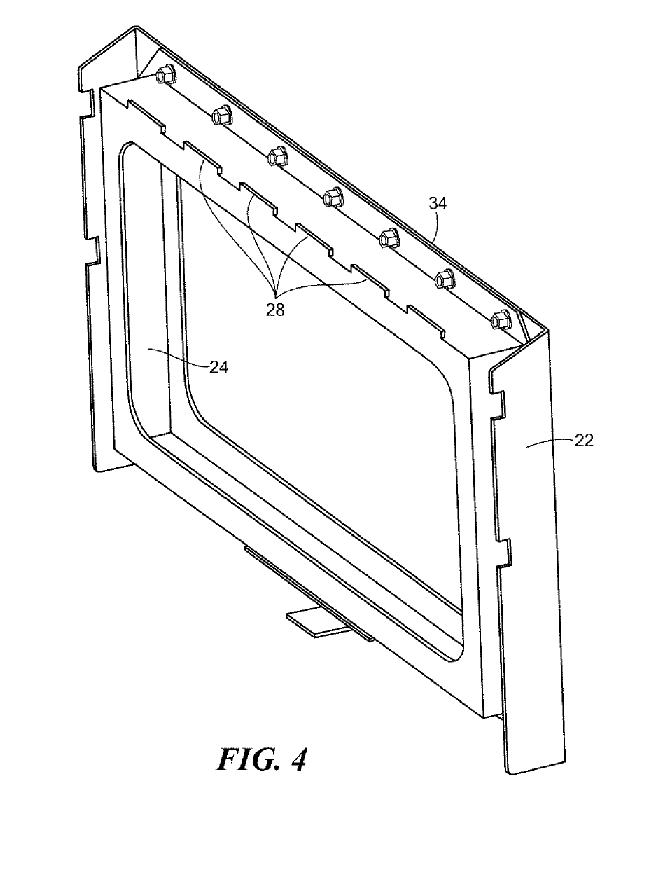

The window assembly 22 is hingedly attached to mount 14 in a fashion such that when the window is opened to a certain extent the hinged structure releases the window assembly 22 from mount 14. As shown in FIGS. 3-4, in one example, the top of window assembly 22 includes inboard, spaced, upwardly extending tabs 28 which fit in the slots defined by spaced bars 30 extending outwardly from the top of mount 14. Further, mount 14 includes top lip 32 and window assembly 22 has top edge 34 spaced laterally from tabs 28 which is engaged under lip 32 of mount 14 when the window opens to a certain extent.

Gas springs 20a and 40b are components of an ejection subsystem in this example and extend between mount 14 via pivoting linkages 42a and 42b and window assembly 22. Latch subsystem 44 functions to releasably lock window assembly 22 closed with respect to mount 14. When latched subsystem 44 is activated to release window assembly 22 from mount 14, gas springs 40a and 40b drive the bottom of window assembly 22 outward from mount 22 and, after a certain amount travel, tabs 28, FIG. 4 automatically release from under bars 30, FIG. 3. The top of window assembly 22 may be driven upward and continues to pivot with respect to mount 14 via lip 32 on the top edge of mount 14 engaging top outer edge 34 of window assembly 22, FIG. 4. After continued travel of window assembly 22, the gas springs 40a and 40b automatically decouple from window assembly 22 and the window assembly is ejected.

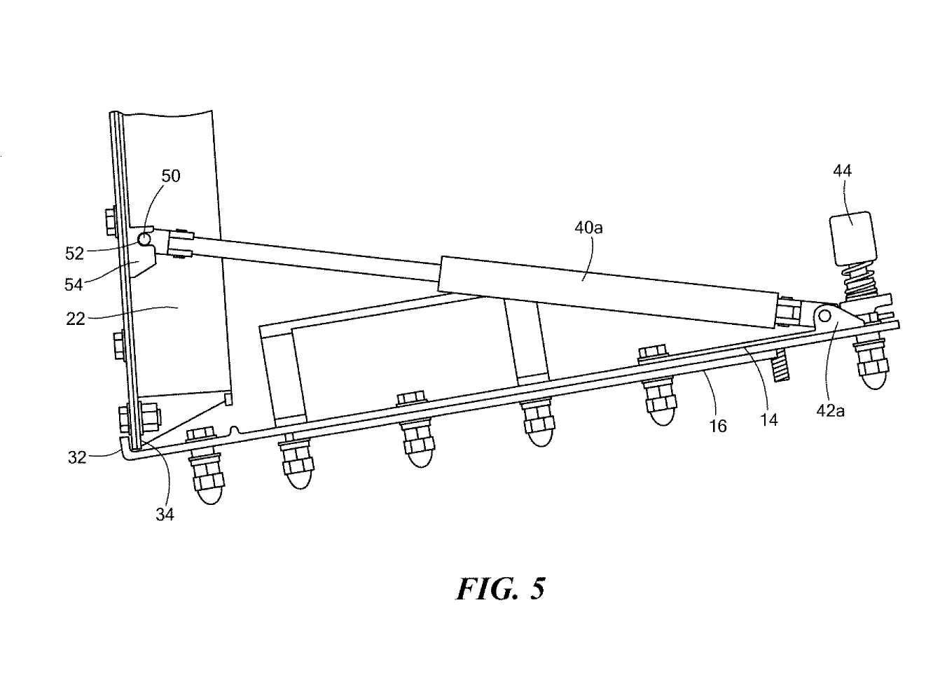

In this particular example, the distal end of the gas springs, as shown FIG. 5, include an ear 50 received in concave channel 52 of side bracket 54 attached to each side of window assembly 22. The biasing force provided by pistons 40a, 40b, urge ear 50 to stay within the side bracket 54 channel 52 for a certain amount of travel of window assembly 22 but then window assembly 22 bracket 54 decouples from gas spring 40a in order to fully release the window assembly from the mount. Other releasable hinge structures, ejection subsystems, and the like are possible, however.

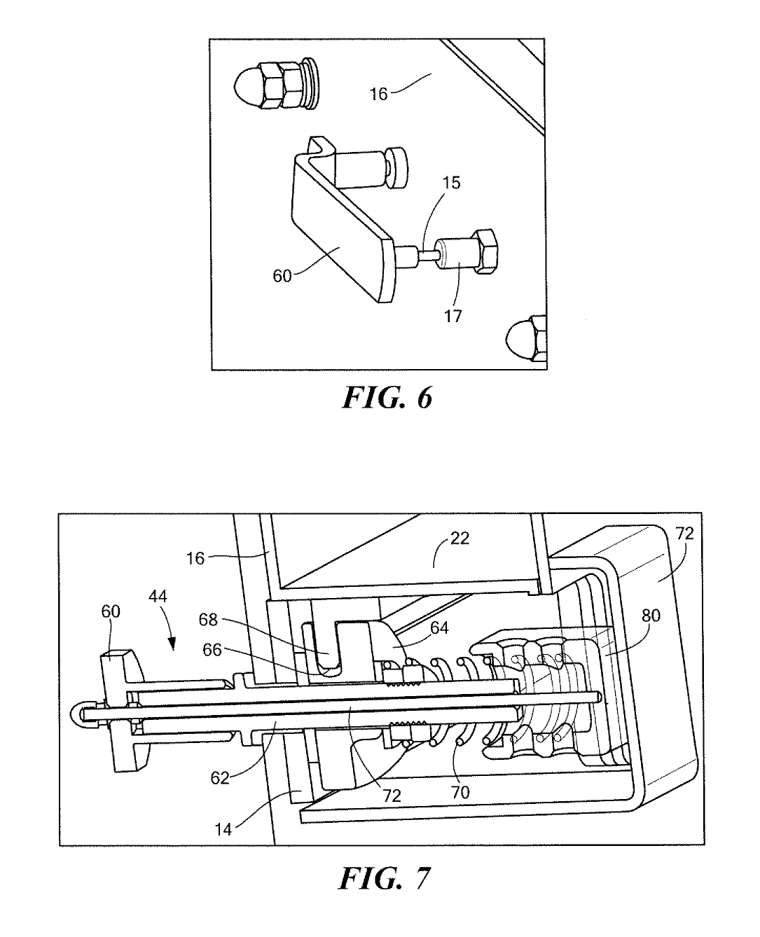

In one particular example, latch assembly 44, FIGS. 6-8 includes handle 60 positioned inside the vehicle and coupled to shaft 62 extending through hull 16 and mount 14 and coupled to a member such as cam 64 with channel 66 receiving therein tab 68 fixed to the bottom frame of window assembly 22. Turning handle 60 turns cam 64 and drives tab 68 out of channel 66. Further turning of cam surface 64 pushes the bottom of the window assembly 22 outward whereupon the gas springs drive the bottom of the window assembly further outward with respect to mount 14.

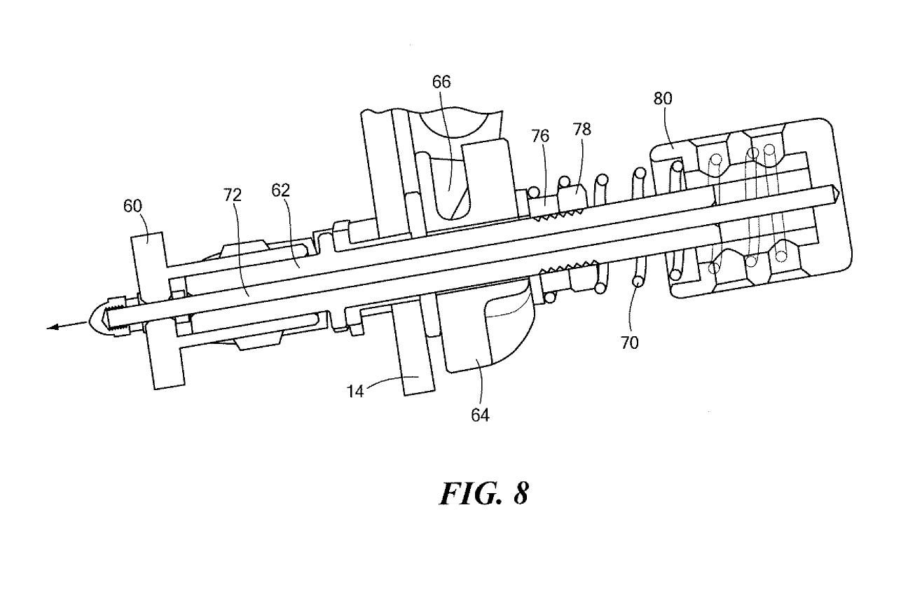

In one preferred design, latch assembly 44 further includes push shaft 72, FIG. 8 within shaft 62, kevlar impregnated nylon bearing 74, washer 76, nut 78, and square drive 80 protected externally via protector 82, FIG. 7 which may be magnetically mounted to the window assembly. Square drive 80 is used to open the window assembly from the exterior of the vehicle. Protective cover 72 is removed with or without tool, to expose and provide access to square drive 80. Square drive 80 is engaged with tool, or other device, and pushed inward towards vehicle, compressing spring 70. As square drive 80 is pushed closer to vehicle, shaft 72, coupled to square drive 80, also is displaced inward toward center of vehicle. Shaft 72 is contained within axle 62 and slides axially with said axle 62. The distal end of shaft 72 is captured within handle 60, and as shaft 72 slides inward towards vehicle, handle 60 is also moved in that same direction. This mechanism couples the motion of square drive 80 directly to handle 60. Square drive 80 must be pressed inward towards vehicle sufficiently to move handle 60 and anti-rotation pin 15, FIG. 6 away from interior surface 16 of vehicle, such that anti-rotation pin 15 decouples from receptacle feature 17 allowing handle 60 to pivot on axis created by axle 62. Once anti-rotation pin 15 is cleared from receptacle feature 17 operator can rotate square drive 80 via tool or other device, thus rotating cam feature 64 to release engagement of window frame 68.

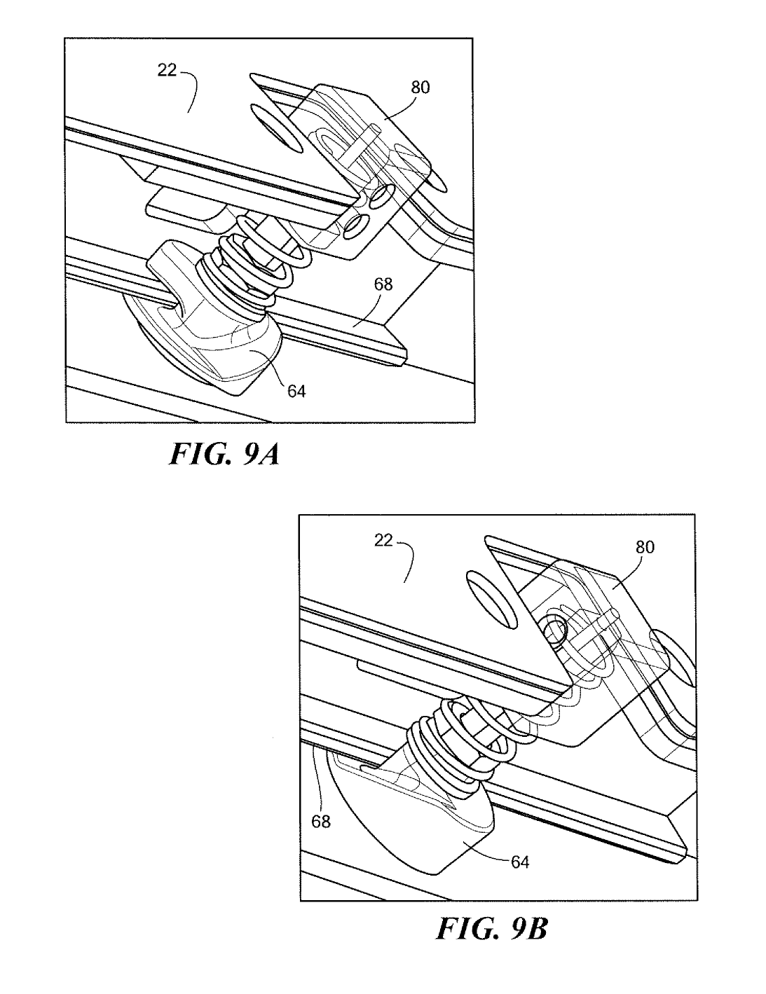

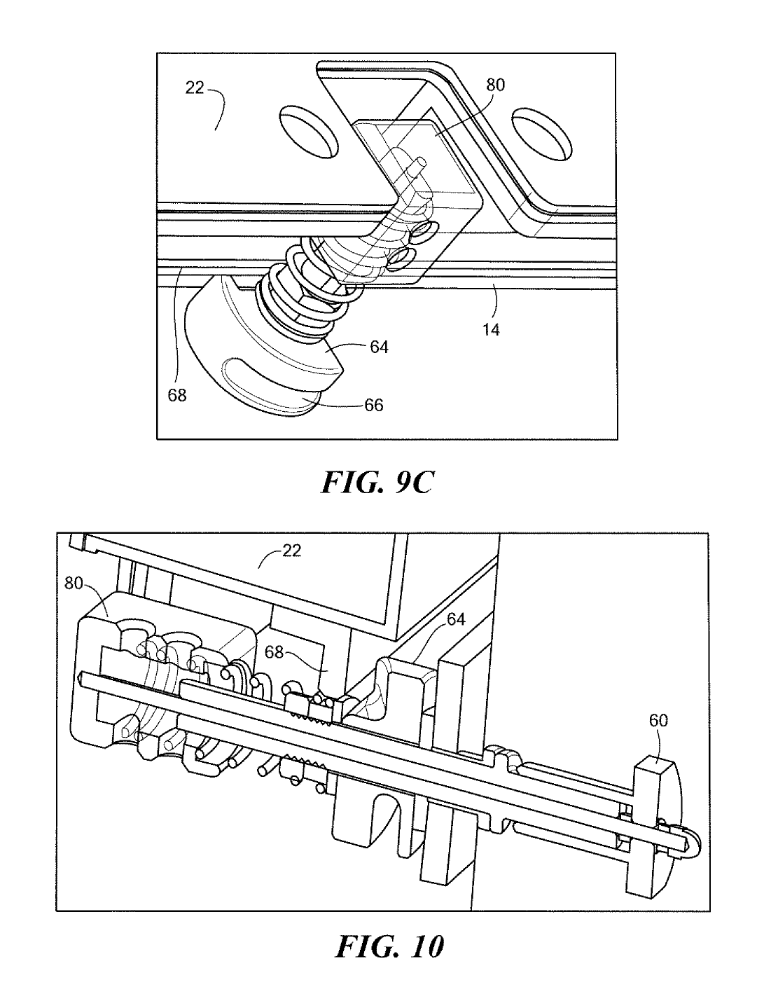

FIG. 9 shows the latch assembly in operation. When window assembly 22 is closed as shown in FIG. 9A, cam 64 is turned 90° as shown in FIG. 9B, and turned 180° as shown in FIG. 9C. Thus, cam 64 releases window assembly 22 from mount 14 and drives the bottom of window assembly outward slightly to free it from any gaskets and the like. See also FIG. 10.

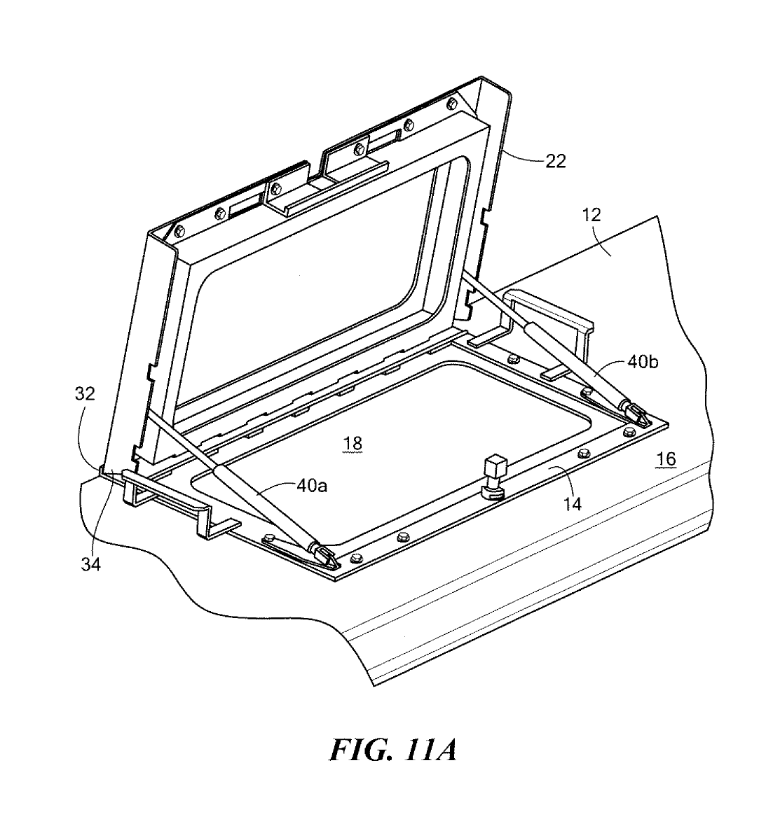

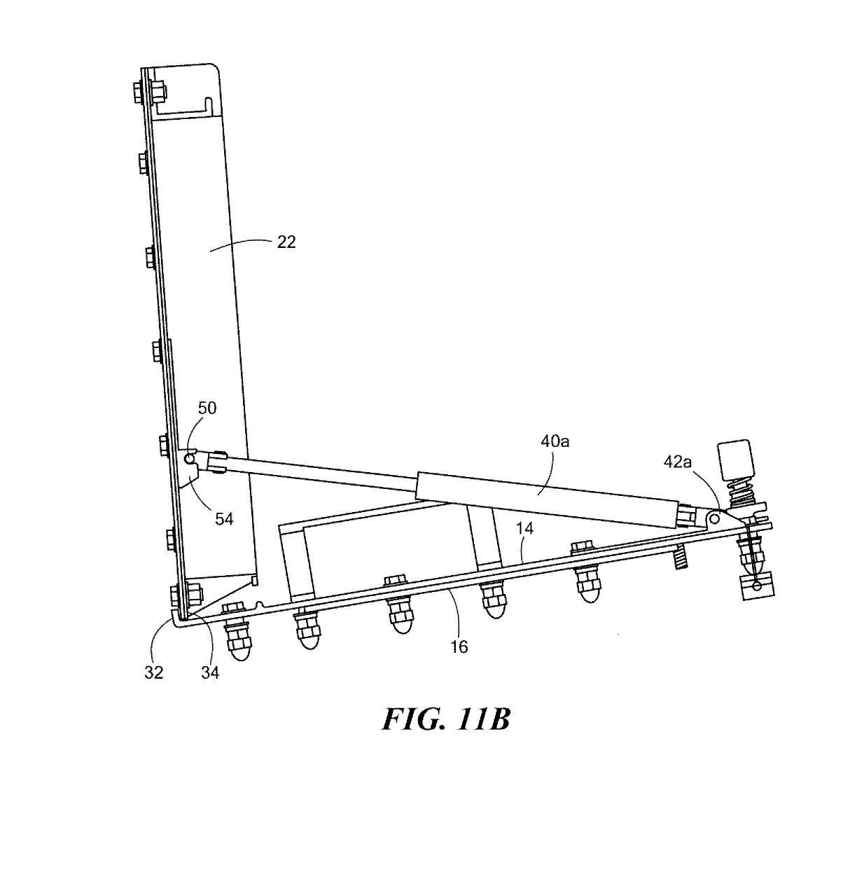

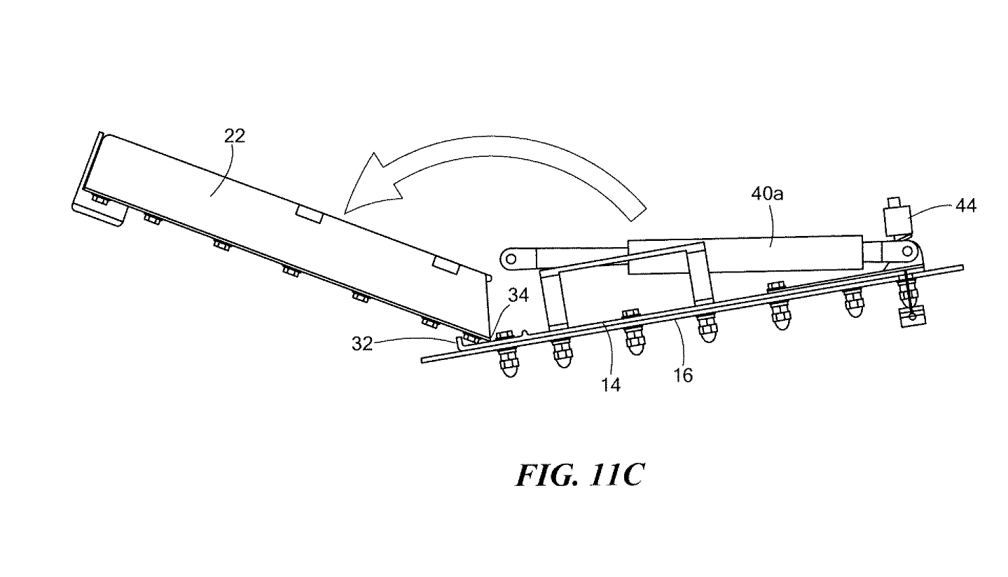

In FIGS. 11A-11C, even when vehicle 12 is on its side in a roll over accident, the ejection subsystem pushes window assembly 22 free from mount 14 and ejects the window assembly 22 for escape of personnel with in the vehicle. The window assembly goes over center and falls due to gravity at approximately 84° of actuation. FIG. 11B shows a full extension of gas spring 40A.

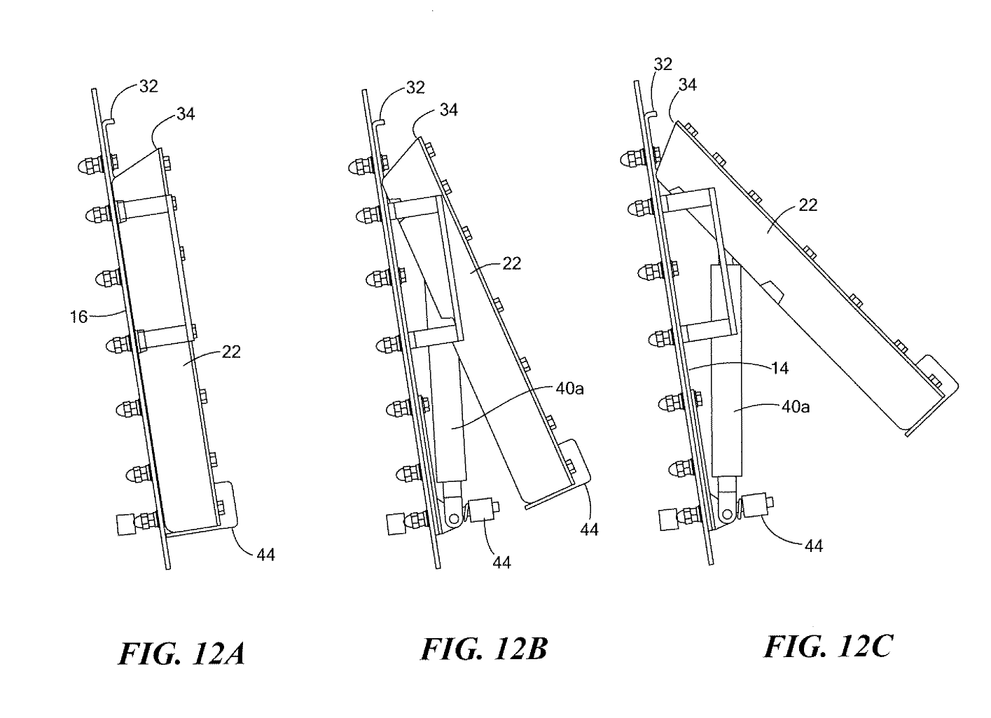

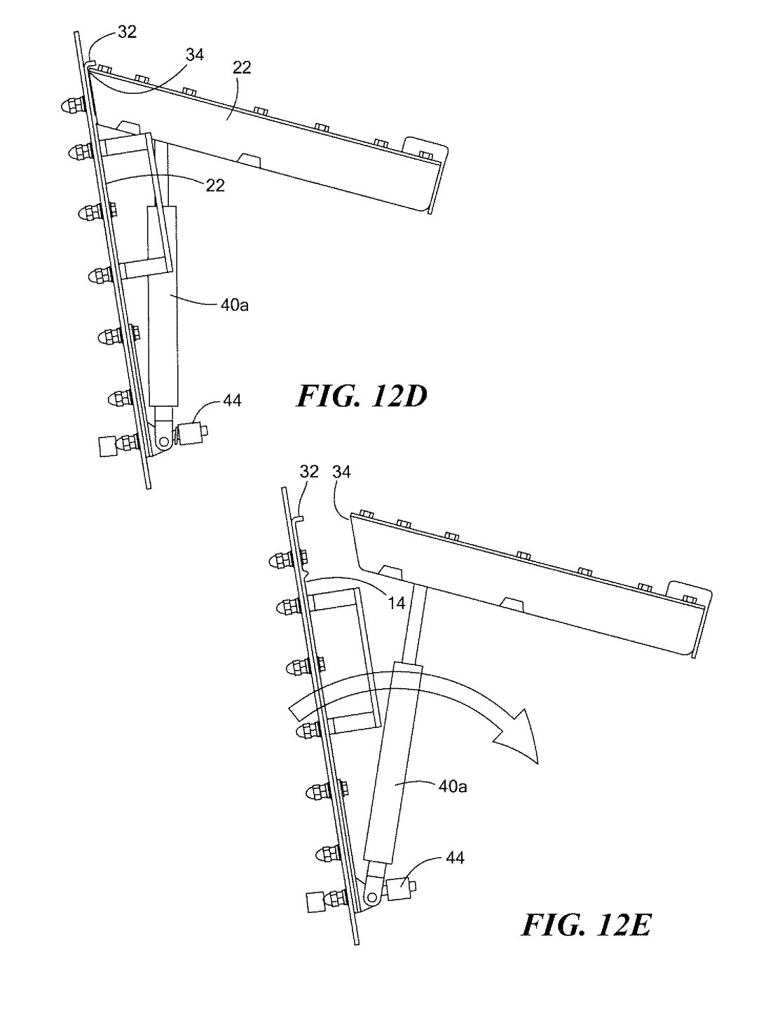

For an upright vehicle, as shown in FIGS. 12A-12E, the ejection subsystem fully ejects window assembly 22 when latch subassembly 44 is activated. The hinge decouples as shown in FIG. 12D and the top edge 34 of window assembly 22 is driven into engagement with lip 32 of mount 14 for further pivoting of window assembly 22 until gas springs 40a and 40b continue to expand and generally assist in ejecting the window assembly as shown in FIG. 12E.

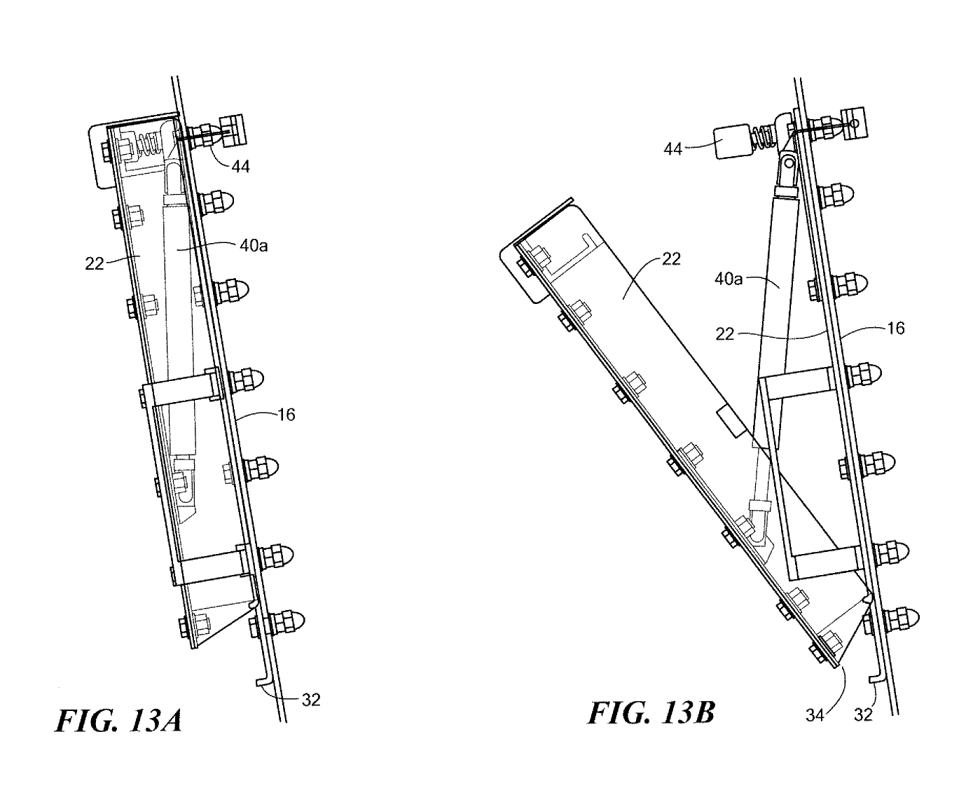

FIGS. 13A-13B show window ejection even when the vehicle rolls upside down. Gravity will pull the window down after clearing release mechanism 44.

In some designs, the latch assembly applies a maximum idle load of 138.5 lbf. The gas springs preferably provide 1.3 times the necessary force to actuate the window in a worse case orientation. The gas springs may provide 130 lbf-in torque to open the window. In the upright orientation, the window will fall due to gravity at approximately 30° of actuation.

Aside from the preferred embodiment or embodiments disclosed, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. An emergency egress system comprising:
a mount securable externally to a vehicle hull about an opening therein and including a first portion of a releasable hinge structure;
a window assembly including a second portion of the releasable hinge structure hingedly attaching the window assembly to the mount over the hull opening;
an ejection subsystem releasably attached to the armor window assembly biasing the armor window assembly outwardly to automatically open the window assembly, decouple the second portion of the hinge structure from the first portion of the hinge structure, and eject the window assembly; and
a latch subsystem actuatable from inside the hull and optionally from outside the hull releasably locking the armor window assembly with respect to the mount in a first configuration and unlocking the armor window assembly with respect to the mount in a second configuration to automatically eject the armor window assembly by operation of the ejection subsystem.

2. The system of claim 1 in which the second portion of the releasable hinge structure includes spaced tabs extending upwardly from the window assembly and the first portion of the releasable hinge structure includes spaced outwardly extending bars on the mount each defining a slot receiving a tab therein.

3. The system of claim 2 in which the mount further includes a top lip and the window assembly includes a top edge spaced laterally from said tabs and driven into engagement under said lip for pivoting the window assembly with respect to the mount after the hinge structure releases.

4. The system of claim 1 in which the ejection subsystem includes a spring in compression on each side of the mount extending therefrom to the armor window assembly.

5. The system of claim 4 in which the springs are gas springs each pivotably mounted at a proximal end to the mount and urged against the armor window assembly at a distal end.

6. The system of claim 5 in which the minor window assembly includes spaced side brackets each including a channel and each gas spring includes a distal ear releasably received in a side bracket channel.

7. The system of claim 1 in which the latch subsystem includes a shaft extending through the hull and the mount and coupled to an external retainer device having a cam surface configured to lock the armor window assembly against the mount when the shaft is turned one direction and to separate the armor window assembly from the mount when the shaft is turned in an opposite direction.

8. An emergency egress system comprising:
a mount securable externally to a vehicle hull about an opening therein and including a first portion of a releasable hinge structure and a lip above said first portion of the releasable hinge structure;
a window assembly including a second portion of the releasable hinge structure hingedly attaching the window assembly to the mount over the hull opening, the window assembly further including a top edge spaced laterally from said releasable hinge structure for engagement under said lip; and
an ejection subsystem releasably attached to the armor window assembly biasing the armor window assembly outwardly to automatically open the window assembly, decouple the second portion of the hinge structure from the first portion of the hinge structure, drive the window assembly top edge into the mount lip, pivot the window assembly with respect to the mount, and eject the window assembly.

9. The emergency egress system of claim 8 further including a latch subsystem actuatable from inside the hull and optionally from outside the hull releasably locking the armor window assembly with respect to the mount in a first configuration and unlocking the armor window assembly with respect to the mount in a second configuration driving the window assembly away from the mount in the second configuration.

10. An emergency egress method comprising:
coupling a window assembly to a mount via a decouping hinge;
biasing the window assembly to open via an ejection subsystem;
latching the window assembly closed with respect to the mount during field operations using a latch; and
in an emergency:
unlatching the window assembly by operating the latch,
automatically opening the window,
automatically decoupling the hinge,
automatically decoupling the ejection subsystem from the window assembly, and
ejecting the window assembly.

11. The method of claim 10 in which the decouping hinge includes spaced tabs extending upwardly from the window assembly and outwardly extending bars on the mount defining slots receiving the tabs therein.

12. The method of claim 10 further including pivoting the window assembly with respect to the mount after the hinge decouples.

13. The method of claim 10 in which opening the window assembly includes pushing a bottom of the window outward using the latch.

14. An emergency egress method comprising:
coupling a window assembly to a mount via a decoupling hinge;
biasing the window assembly to open an via ejection subsystem;
latching the window assembly closed with respect to the mount during field operations using a latch; and
in an emergency:
unlatching the window assembly by operating the latch which urges the window assembly to separate from the mount,
automatically driving the window open,
automatically decoupling the hinge,
automatically decoupling the ejection subsystem from the window assembly, and
ejecting the window assembly.

15. The method of claim 14 further including pivoting the window assembly with respect to the mount after decoupling the hinge.
